(19) United States
(12) Patent Application Publication
(10) Pub. No.: US 2018/0199284 A1
(43) Pub. Date: Jul. 12, 2018

(54) COMMUNICATIONS APPARATUS AND METHOD FOR REDUCING POWER CONSUMPTION OF A COMMUNICATIONS APPARATUS

(71) Applicant: MEDIATEK INC., Hsin-Chu (TW)

(72) Inventors: Chih-Chieh LAI, New Taipei City (TW); Jianwei ZHANG, Beijing (CN); Wei-Jen CHEN, Taipei City (TW)

(21) Appl. No.: 15/408,700

(22) Filed: Jan. 18, 2017

(30) Foreign Application Priority Data
Jan. 10, 2017 (CN) 201710015755.2

(51) Int. Cl. H04W 52/02; H04W 72/04

(52) U.S. Cl. CPC H04W 52/028; H04W 72/042

(57) ABSTRACT

A communications apparatus includes an antenna module, multiple front-end signal processing circuits, and a processor. The antenna module transmits and receives RF signals for communicating with a network device and includes at least one antenna. Each front-end signal processing circuit is coupled to the antenna module for receiving the RF signals and processing the RF signals. The processor is coupled to the front-end signal processing circuits. The processor determines whether there is any downlink data to be received from the network device according to the content of received RF signals. When there is some downlink data to be received from the network device, the processor determines to turn off at least one front-end signal processing circuit and only use the remaining front-end signal processing circuits to process the received RF signals.

### CROSS REFERENCE TO RELATED APPLICATIONS

This Application claims priority of China Patent Application No. 201710015755.2, filed on Jan. 10, 2017, the entirety of which is incorporated by reference herein.

### BACKGROUND OF THE INVENTION

### Field of the Invention

The invention relates to a communications apparatus and methods for reducing power consumption by a communications apparatus.

### Description of the Related Art

With the emerging technologies of cellular networks, embedded systems, and the

Internet, mobile communications devices (apparatuses) such as smartphones and tablets have become popular because they combine the mobility of a cellular phone with the functionality of a computer or personal digital assistant (PDA) into a single device.

Because the power supply in mobile communications devices is often limited to batteries, how to reduce the power consumption and extend the standby and operation time of the mobile communications devices are issues worthy of concern.

Therefore, methods for reducing power consumption by a communications apparatus are required.

### BRIEF SUMMARY OF THE INVENTION

A communications apparatus and method for reducing power consumption of a communications apparatus are provided. An exemplary embodiment of a communications apparatus comprises an antenna module, a plurality of front-end signal processing circuits, and a processor. The antenna module transmits and receives RF signals for communicating with a network device and comprises at least one antenna. Each front-end signal processing circuit is a signal processing chain and coupled to the antenna module for receiving the RF signals and processing the RF signals. The processor is coupled to the front-end signal processing circuits. The processor determines whether there is any downlink data to be received from the network device according to content of received RF signals. When there is some downlink data to be received from the network device, the processor determines to turn off at least one front-end signal processing circuit and only use the remaining front-end signal processing circuit(s) to process the received RF signals

An exemplary embodiment of a method for reducing power consumption of a communications apparatus comprising a plurality of front-end signal processing circuits and a processor, comprises: determining whether there is any downlink data to be received from a network device according to content of one or more radio frequency signals received by the communications apparatus; and determining whether to turn off at least one signal processing circuit and only use the remaining front-end signal processing circuit(s) to process the received RF signals. When there is some downlink data to be received from the network device, a determination is made to turn off any signal processing circuits.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary block diagram of a communications apparatus according to an embodiment of the invention;

FIG. 2 shows an exemplary block diagram of a front-end signal processing circuit according to an embodiment of the invention;

FIG. 3 is an exemplary diagram showing a result of dynamically controlling a number of signal processing chains for reducing power consumption of the communications apparatus according to an embodiment of the invention;

FIG. 4 is an exemplary diagram showing a result of dynamically controlling a number of signal processing chains for reducing power consumption of the communications apparatus according to another embodiment of the invention; and

FIG. 5 is a flow chart showing a method for reducing power consumption of a communications apparatus according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

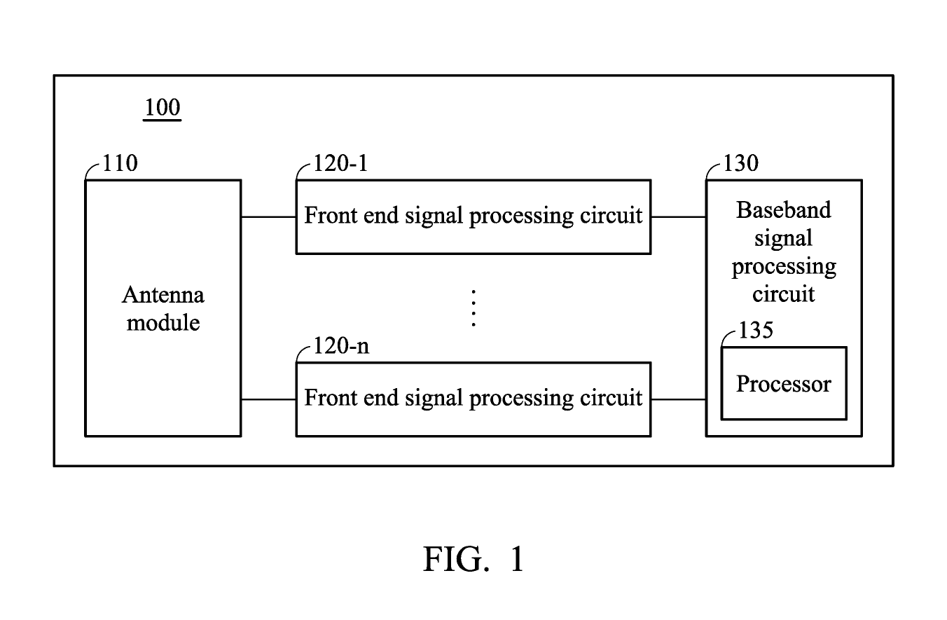

FIG. 1 shows an exemplary block diagram of a communications apparatus according to an embodiment of the invention. The communications apparatus 100 may be a portable electronic device or a mobile communications device, such as a Mobile Station (MS, which may be interchangeably referred to as User Equipment (UE)). The communications apparatus 100 may comprise at least an antenna module 110 comprising at least one antenna, a plurality of front-end signal processing circuits 120-1 . . . 120-n, where n is a positive integer, and a baseband signal processing circuit 130.

The antenna module 110 is capable of transmitting and receiving a plurality of radio frequency (RF) signals for facilitating the communications apparatus 100 to communicate with a network device. According to an embodiment of the invention, the network device may be a cell, an evolved node B, a base station, a Mobility Management Entity (MME) etc., at the network side and communicating with the communications apparatus 100 via the radio frequency signals.

Each front-end signal processing circuit 120-1 . . . 120-n may comprise a plurality of hardware devices to form a signal processing chain for processing the RF signals received from the antenna module 110 to generate intermediate frequency (IF) or baseband signals, or for processing IF or baseband signals received from the baseband signal processing circuit 130 to generate the RF signals to be transmitted via the antenna module 110. Note that, in the embodiments of the invention, the front-end signal processing circuit and the antenna(s) coupled to the corresponding front-end signal processing circuit may also be regarded as a signal processing chain for receiving and processing the RF signals. Therefore, the invention should not be limited thereto.

The baseband signal processing circuit 130 may receive the IF or baseband signals from the front-end signal processing circuits and perform IF or baseband signal processing. The baseband signal processing circuit 130 may comprise a processor 135 and a plurality of hardware devices to perform signal processing, such as a analog-to-digital converter circuit for ADC conversion, a digital-to-analog converter circuit for DAC conversion, an amplifier circuit for gain adjustment, a modulator circuit for signal modulation, a demodulator circuit for signal demodulation, a encoder circuit for signal encoding, a decoder circuit for signal decoding, and so on.

Note that, in order to clarify the concept of the invention, FIG. 1 presents a simplified block diagram in which only the elements relevant to the invention are shown. For example, in some embodiments of the invention, the communications apparatus may further comprise some peripheral devices not shown in FIG. 1. Therefore, the invention should not be limited to what is shown in FIG. 1.

According to an embodiment of the invention, the processor 135 may dynamically control a number of signal processing chains for processing the RF signals, so as to reduce power consumption of the communications apparatus 100.

To be more specific, according to an embodiment of the invention, the processor 135 may determine whether there is any downlink data to be received from the network device according to content of received RF signals. When there is some downlink data to be received from the network device, the processor may further determine or predict a transmit scheme to be used by the network device to transmit the downlink data. When the processor 135 determines or predicts that a spatial multiplexing scheme is not or will not be used by the network device to transmit the downlink data, the processor 135 may determine to turn off at least one front-end signal processing circuit and only use the remaining front-end signal processing circuit(s) to receive and process the received RF signals. That is, the processor 135 may determine not to use all the signal processing chains for receiving and processing the RF signals, so as to reduce power consumption of the communications apparatus 100.

According to an embodiment of the invention, the processor may turn off at least one front-end signal processing circuit by turning off one or more devices comprised in the front-end signal processing circuits.

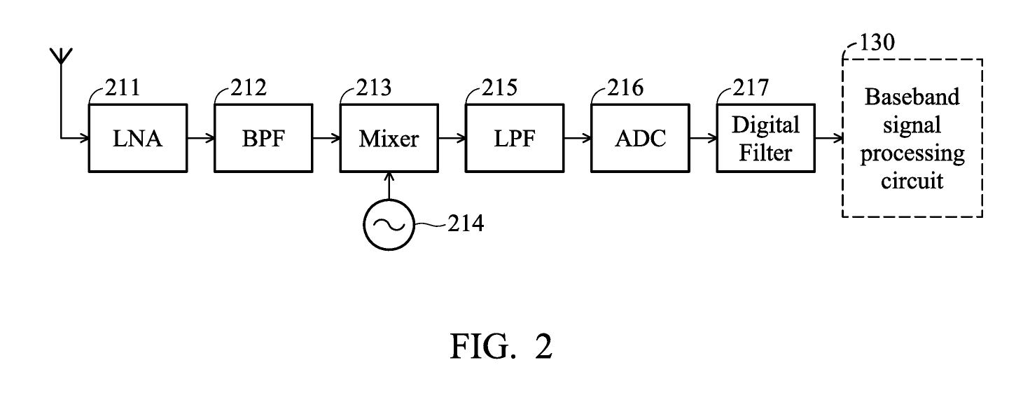

FIG. 2 shows an exemplary block diagram of a front-end signal processing circuit according to an embodiment of the invention. The front-end signal processing circuit may comprise a low noise amplifier LNA 211, a bandpass filter BPF 212, a mixer 213 coupled to an oscillator 214, a low pass filter LPF 215, an ADC 216 and a digital filter 217. According to an embodiment of the invention, when the processor 135 determines to turn off the front-end signal processing circuit as shown in FIG. 2, the processor 135 may control one or more devices, such as the LNA 211, the LPF 215, the ADC 216 and the digital filter 217, to be turned off within a predetermined time period. For example, the processor 135 may transmit a control signal to the devices, so as to trigger the corresponding firmware to power down the corresponding devices.

Note that FIG. 2 is only one of a plurality of possible implementations of a front-end signal processing circuit. Those who are skilled in this technology will readily appreciate that, for different system requirements, various alterations and combinations of signal processing devices can be made to implement different designs for a front-end signal processing circuit. Therefore, the invention should not be limited thereto.

According to an embodiment of the invention, the processor 135 may determine whether there is any downlink data to be received from the network device by decoding a Physical Downlink Control Channel (PDCCH) signal comprised in the received RF signal. The PDCCH signal is usually carried in the first few symbols within a sub-frame.

According to an embodiment of the invention, the processor 135 may further determine the transmit scheme according to the PDCCH signal decoding result. When the PDCCH signal decoding result shows that a spatial multiplexing scheme is not or will not be used by the network device to transmit the downlink data, the processor 135 may determine to turn off at least one front-end signal processing circuit and only use the remaining front-end signal processing circuit(s) to process the received RF signals.

On the other hand, when the PDCCH signal decoding result shows that a spatial multiplexing scheme is or will be used by the network device to transmit the downlink data, the processor 135 may determine not to turn off any front-end signal processing circuits.

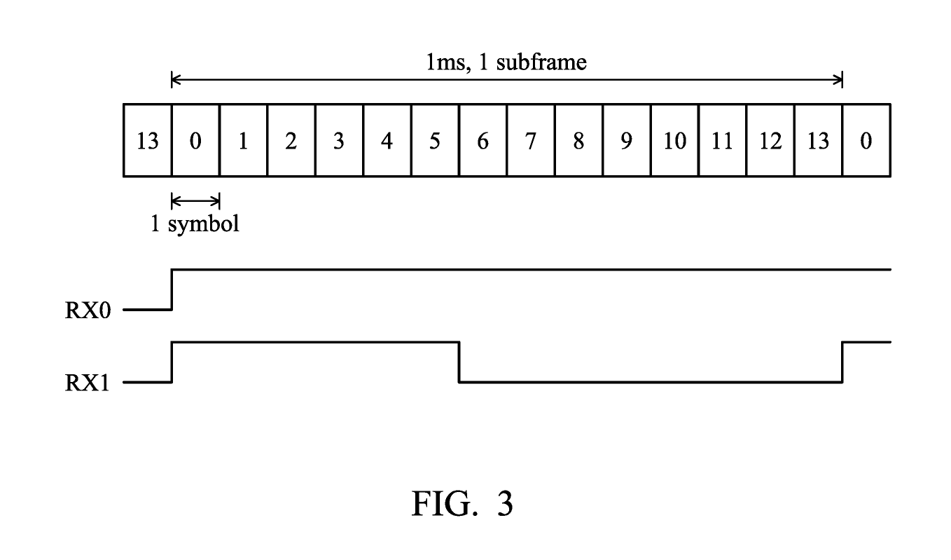

FIG. 3 is an exemplary diagram showing a result of dynamically controlling a number of signal processing chains for reducing power consumption of the communications apparatus according to an embodiment of the invention. Suppose that in this example, there are two front-end signal processing circuits comprised in the communications apparatus, forming a first signal processing chain RX0 and a second signal processing chain RX1.

The processor 135 may decode the PDCCH signal of a sub-frame to check whether there is any downlink data to be received from the network device and the transmit scheme adopted by the network device when there is some downlink data allocated. When the processor 135 obtains the PDCCH signal decoding result at the end of symbol 5 and the PDCCH signal decoding result shows that the downlink data is allocated and a transmit diversity scheme is adopted by the network device, the processor 135 may further determine whether the channel condition of a channel utilized for communicating with the network device is allowed for the communications apparatus to turn off at least one signal processing chain.

According to an embodiment of the invention, the processor 135 may check the signal-to-noise ratio (SNR) performance of each signal processing chain, the coding scheme adopted by the network device, and/or the modulation and coding scheme (MCS) index adopted by the network device, to determine the data protection capability of the signal processing chains.

As an example, when the coding scheme or the MCS adopted by the network device has poor data protection capability, the processor 135 may determine that the channel condition is not allowed for the communications apparatus to turn off at least one signal processing chain. Generally, the 256QAM has poorer data protection capability than QPSK.

In another example, when the coding scheme or the MCS adopted by the network device has good data protection capability, and the processor 135 finds that the SNR performance in RX0 is better than RX1 and is good enough for the RX0 to successfully receive and process the RF signals when the RX0 operates solely, the processor 135 may determine to turn off the second signal processing chain RX1 within the time period of the sub-frame after symbol 5, and use only the first signal processing chain RX0 to receive and process the RF signals.

In FIG. 3, the curves corresponding to each signal processing chain represent the power consumption thereof. As shown in FIG. 3, after symbol 5, the second signal processing chain RX1 is turned off and thus the power consumption is reduced.

Note that in some embodiments of the invention, the processor 135 may turn off the second signal processing chain RX1 at the beginning of the sub-frame and use only the first signal processing chain RX0 to receive and process the RF signals, including decoding the PDCCH signal, for further reducing the power consumption, and the invention should not be limited thereto.

According to another embodiment of the invention, the processor 135 may further determine the transmit scheme according to the value of a rank indicator (RI) to be reported, or one that has been reported, to the network device. When the value of the rank indicator indicates that a spatial multiplexing scheme is not recommended to be used to transmit the downlink data, the processor 135 may determine to turn off at least one front-end signal processing circuit and only use the remaining front-end signal processing circuit(s) to process the received RF signals.

On the other hand, when the rank indicator indicates that a spatial multiplexing scheme is recommended to be used by the network device to transmit the downlink data, the processor 135 may determine not to turn off any front-end signal processing circuit.

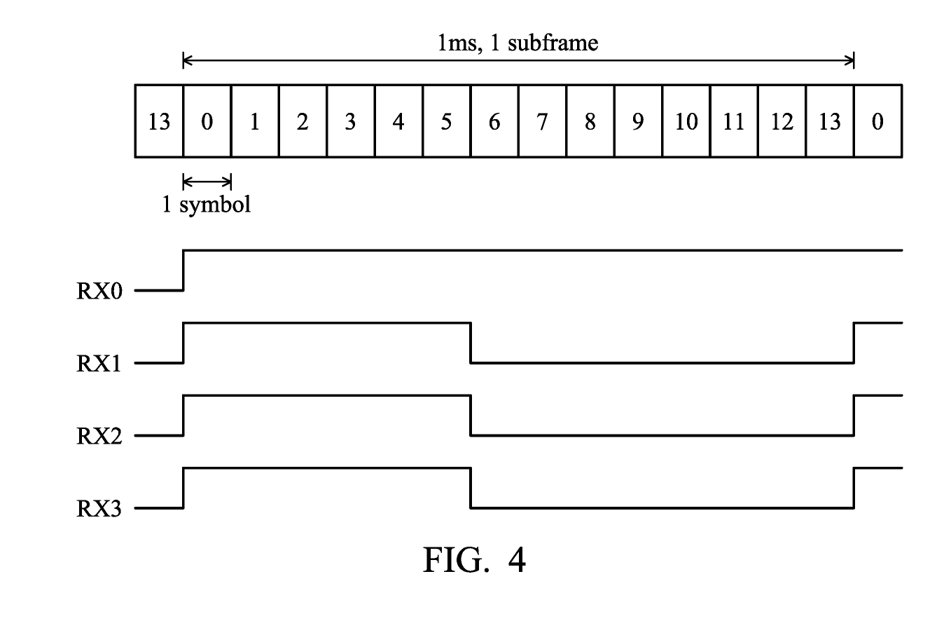

FIG. 4 is an exemplary diagram showing a result of dynamically controlling a number of signal processing chains for reducing power consumption of the communications apparatus according to another embodiment of the invention. Suppose that in this example, there are four front-end signal processing circuits comprised in the communications apparatus, forming a first signal processing chain RX0, a second signal processing chain RX1, a third signal processing chain RX2 and a fourth signal processing chain RX3.

The processor 135 may decode the PDCCH signal of a sub-frame to check whether there is any downlink data to be received from the network device and check the RI value to be reported or has been reported to the network device. When the processor 135 obtains the PDCCH signal decoding result at the end of symbol 5 and the PDCCH signal decoding result shows or indicates that a spatial multiplexing scheme is not used by the network devices, the processor 135 may further determine whether the channel condition is allowed for the communications apparatus to turn off at least one signal processing chain.

As discussed above, the processor 135 may check the signal-to-noise ratio (SNR) performance of each signal processing chain, the coding scheme adopted by the network device, and/or the modulation and coding scheme (MCS) index adopted by the network device, to determine the data protection capability of the signal processing chains.

As an example, when the coding scheme or the MCS adopted by the network device has poor data protection capability, the processor 135 may determine that the channel condition is not allowed for the communications apparatus to turn off at least one signal processing chain.

In another example, when the coding scheme or the MCS adopted by the network device has good data protection capability, and the processor 135 finds that the SNR performance in RX0 better than the others and is good enough for the RX0 to successfully receive and process the RF signals when the RX0 operates solely, the processor 135 may determine to turn off the other chains RX1˜RX3 within the time period of the sub-frame after symbol 5 as shown in FIG. 4, and use only the first signal processing chain RX0 to receive and process the RF signals.

Note that in some embodiments of the invention, the processor 135 may partially turn off the some signal processing chain(s) at the beginning of the sub-frame and use only fewer signal processing chain(s) to receive and process the RF signals, including decoding the PDCCH signal, for further reducing the power consumption, and the invention should not be limited thereto.

Note that, in cases where the communications apparatus 100 has to monitor the PDCCH signal and check whether there is any downlink data to be received every sub-frame, the processor 135 may dynamically control the number of signal processing chains in every sub-frame. In addition, unlike conventional designs in which the power consumption is usually high and will not be reduced after determining that there is any downlink data to be received, based on the concept of the invention, the power consumption can still be reduced even when there is some downlink data to be received.

In addition, the timing resolution to control the power consumption is fine to a symbol-level, which is also finer than in conventional designs. Based on the concept of the invention, the processor 135 may control the front-end signal processing circuit (that is, determine whether to turn on or off at least one front-end signal processing circuit) per sub-frame, and turn on or off at least one front-end signal processing circuit in a predetermined symbol within a sub-frame.

In addition, unlike conventional designs, in the embodiments of the invention, after reporting the RI to the network device, the processor 135 may directly predict the transmit scheme to be used by the network device (since the network device will not transmit any feedback to the communications apparatus 100 to respond to the received RI), and control the front-end signal processing circuit based on the reported RI. Therefore, the proposed controlling methods are more efficient than conventional designs.

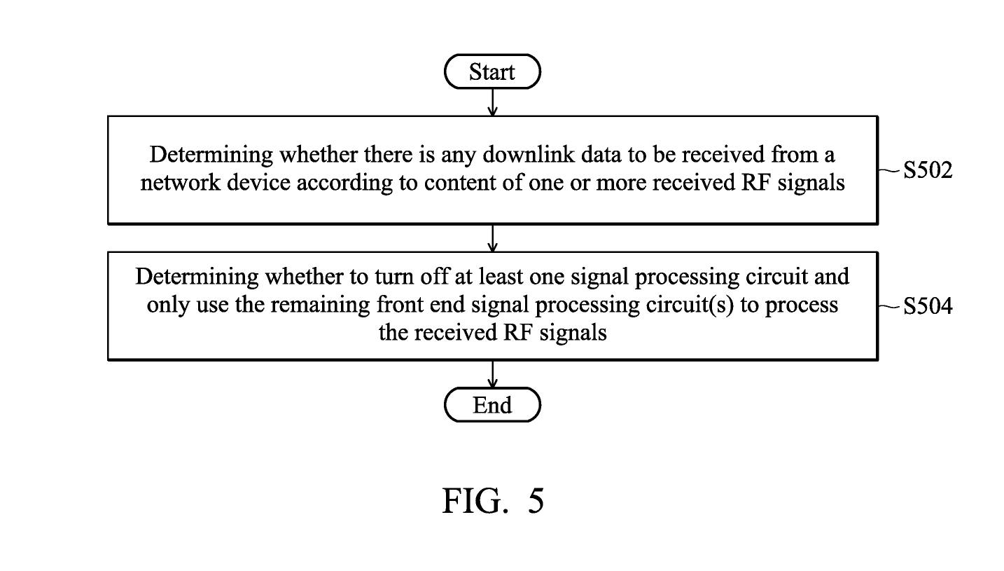

FIG. 5 is a flow chart showing a method for reducing power consumption of a communications apparatus according to an embodiment of the invention. The processor of the communications apparatus may first determine whether there is any downlink data to be received from a network device according to content of one or more received RF signals (Step S502). Next, the processor may determine whether to turn off at least one signal processing circuit and only use the remaining front-end signal processing circuit(s) to process the received RF signals (Step S504). When there is some downlink data to be received from the network device, and a spatial multiplexing scheme is determined or predicted not to be used by the network device to transmit the downlink data, the processor may determine to turn off at least one signal processing circuit.

The embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general-purpose hardware that is programmed using microcode or software to perform the functions recited above.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus, comprising:
an antenna module, transmitting and receiving a plurality of radio frequency (RF) signals for communicating with a network device and comprising at least one antenna;
a plurality of front-end signal processing circuits, coupled to the antenna module for receiving the RF signals and processing the RF signals; and
a processor, coupled to the front-end signal processing circuits,
wherein the processor determines whether there is any downlink data to be received from the network device according to content of received RF signals, and when there is some downlink data to be received from the network device, the processor determines to turn off at least one front-end signal processing circuit and only use the remaining front-end signal processing circuit(s) to process the received RF signals.

2. The communications apparatus as claimed in claim 1, wherein the processor determines whether there is any downlink data to be received from the network device by decoding a Physical Downlink Control Channel (PDCCH) signal comprised in the received RF signal.

3. The communications apparatus as claimed in claim 1, wherein the processor further determines a transmit scheme to be used by the network device to transmit the downlink data, and when the processor determines that a spatial multiplexing scheme is not used to transmit the downlink data, the processor determines to turn off the at least one front-end signal processing circuit.

4. The communications apparatus as claimed in claim 1, wherein the processor further determines a rank indicator value to be reported to the network device, and when the value of the rank indicator indicates that a spatial multiplexing scheme is not recommended to be used to transmit the downlink data, the processor determines to turn off the at least one front-end signal processing circuit.

5. The communications apparatus as claimed in claim 1, wherein the processor determines whether to turn on or off the at least one front-end signal processing circuit per sub-frame.

6. The communications apparatus as claimed in claim 2, wherein after decoding the PDCCH signal of a sub-frame, the processor turns off the at least one front-end signal processing circuit within the time period of the sub-frame.

7. The communications apparatus as claimed in claim 1, wherein the processor determines whether to turn on or off the at least one front-end signal processing circuit according to channel condition.

8. A method for reducing power consumption of a communications apparatus comprising a plurality of front-end signal processing circuits and a processor, comprising:
determining whether there is any downlink data to be received from a network device according to content of one or more radio frequency signals received by the communications apparatus; and
determining whether to turn off at least one signal processing circuit and only use the remaining front-end signal processing circuit(s) to process the received RF signals,
wherein when there is some downlink data to be received from the network device, a determination is made to turn off the at least one signal processing circuit.

9. The method as claimed in claim 8, wherein the step of determining whether there is any downlink data to be received from the network device is performed by decoding a Physical Downlink Control Channel (PDCCH) signal comprised in the received RF signal.

10. The method as claimed in claim 8, further comprising:
determining a transmit scheme to be used by the network device to transmit the downlink data,
wherein when a spatial multiplexing scheme is not used to transmit the downlink data, a determination is made to turn off the at least one signal processing circuit.

11. The method as claimed in claim 8, further comprising:
determining a rank indicator value to be reported to the network device,
wherein when the value of the rank indicator indicates that a spatial multiplexing scheme is not recommended to be used to transmit the downlink data, a determination is made to turn off the at least one signal processing circuit.

12. The method as claimed in claim 8, wherein the step of determining whether to turn off the at least one front-end signal processing circuit is performed per sub-frame.

13. The method as claimed in claim 9, wherein after the PDCCH signal of a sub-frame is decoded, the at least one signal processing circuit is turned off within the time period of the sub-frame.

14. The method as claimed in claim 8, wherein whether to turn off at least one signal processing circuit and only use the remaining front-end signal processing circuit(s) to process the received RF signals is determined based on channel condition of a channel
